(19) United States
(12) Patent Application Publication
(10) Pub. No.: US 2025/0335706 A1
(43) Pub. Date: Oct. 30, 2025

(54) Estimating Evaluations Of System-Generated Computational Metrics Corresponding To The Output Of A Machine Learning Model

(71) Applicant: Oracle International Corporation, Redwood Shores, CA (US)

(72) Inventors: Iman Zadeh, Los Angeles, CA (US); Jun Qian, Bellevue, WA (US)

(73) Assignee: Oracle International Corporation, Redwood Shores, CA (US)

(21) Appl. No.: 18/646,603

(22) Filed: Apr. 25, 2024

(51) Int. Cl. G06F 40/20

(52) U.S. Cl. CPC G06F 40/20

(57) ABSTRACT

Techniques for evaluating the output of a large language model are disclosed. A training data set that includes deterministic computational metrics that measure features of large language model output and qualitative metrics that provide a non-deterministic measure of large language model output quality may be used to train a ML model. The ML model may then be used to estimate the qualitative metrics of large language model output by using deterministic computational metrics as input.

### TECHNICAL FIELD

The present disclosure relates to large language models. In particular, the present disclosure relates to assessing the performance of large language models.

### BACKGROUND

Large language models (LLMs) are sophisticated machine learning constructs used for processing, understanding, and generating human language, leveraging the power of neural networks. These models are trained on vast collections of text snippets, allowing them to process and model the nuances and grammatical frameworks of multiple languages. Through unsupervised learning methods, LLMs predict subsequent words or tokens in sentences, enhancing their linguistic proficiency. This capability allows them to perform a myriad of natural language processing tasks, such as translation, summarization, and question answering, by understanding and generating text that aligns with the given context.

Given the expanding role of Large Language Models (LLMs) across various sectors, methods have been developed for assessing the quality and reliability of their outputs. As these models contribute to decision-making processes, content generation, and user interactions, users of large language models seek to ensure the outputs are accurate, fair, and appropriate for the context. By establishing evaluation frameworks, stakeholders can better understand and improve the performance of LLMs, supporting their more responsible use in different areas.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a machine learning engine 100 in accordance with one or more embodiments;

FIG. 2 illustrates the operation of a machine learning engine in one or more embodiments;

FIG. 3 illustrates an output evaluation agent 300 in accordance with one or more embodiments;

FIG. 4 illustrates an example set of operations for evaluating ML model output in accordance with one or more embodiments;

FIG. 5 illustrates an example set of operations for comparing ML models that are trained to evaluate output from a different ML model in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. MACHINE LEARNING ARCHITECTURE
3. LARGE LANGUAGE MODELS
4. OUTPUT EVALUATION-DETERMINISTIC COMPUTATIONAL METRICS
5. OUTPUT EVALUATION-QUALITATIVE METRICS
6. OUTPUT EVALUATION AGENT ARCHITECTURE
7. EVALUATING ML MODEL OUTPUT
8. COMPUTER NETWORKS AND CLOUD NETWORKS
9. HARDWARE OVERVIEW
10. MISCELLANEOUS; EXTENSIONS

### 1. General Overview

One or more embodiments evaluate system-generated computational metrics, corresponding to the output of a target machine learning (ML) model, using an evaluation ML model. In an example, the target ML model is a Large Language Model (LLM), and the evaluation ML model is a neural network. Initially, the system accesses a training data set for training the evaluation ML model. The training data set includes a set of system-generated computational metrics corresponding to the output of the target ML model. The computational metrics may be deterministic metrics that represent certain attributes of the output, such as semantic similarity, likelihood of the generated text based on context, grammar, coherence, or other scores that may be consistently calculated based on the output. The training data also includes a label corresponding to a human evaluation of the output of the target ML model. The system trains the evaluation ML model, using the training data set, to estimate human evaluations of system-generated output from the target ML model. The system then applies the trained evaluation ML model, to a set of system-generated computational metrics for additional output generated by the target ML model, to generate estimated human evaluations.

One or more embodiments estimate an LLM's (non-deterministic) qualitative evaluations of the output a target ML model by a qualitative evaluation ML model. In an example, the target ML model and qualitative evaluation ML model are both neural networks. Initially, the system accesses a training data set for training the qualitative evaluation ML model. The training data set includes a set of system-generated computational metrics corresponding to the output of the target ML model. Similar to above example, the computational metrics may be deterministic metrics that represent certain attributes of the output, such as semantic similarity, likelihood of the generated text based on context, grammar, coherence, or other scores that may be consistently calculated based on the output. The training data also includes a label corresponding to a qualitative evaluation of the output of the target ML model, generated by a LLM. The system trains the qualitative evaluation ML model, using the training data set, to estimate an LLM's qualitative evaluations of system-generated computational metrics corresponding to the output of the target ML model. The system then applies the trained qualitative evaluation ML model, to a set of system-generated computational metrics for additional output generated by the target ML model, to estimate the LLM's qualitative evaluations.

One or more embodiments described in this Specification and/or recited in the claims may not be included in this General Overview section.

### 2. Machine Learning Architecture

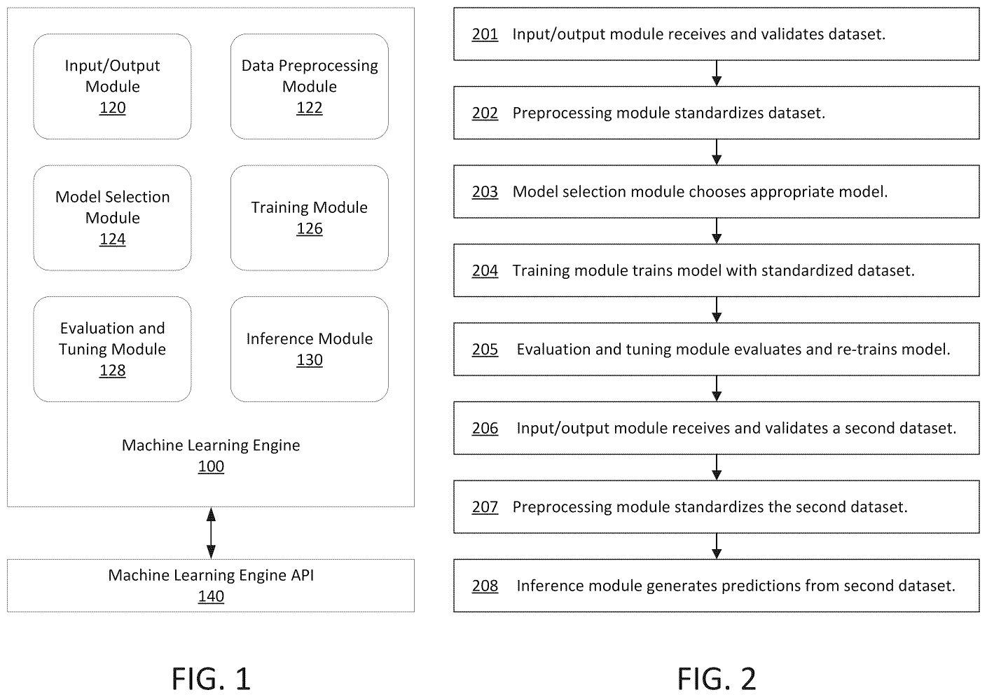

FIG. 1 illustrates a machine learning engine 100 in accordance with one or more embodiments. As illustrated in FIG. 1, machine learning engine 100 includes input/output module 120, data preprocessing module 122, model selection module 124, training module 126, evaluation and tuning module 128, and inference module 130.

In accordance with an embodiment, input/output module 120 serves as the primary interface for data entering and exiting the system, managing the flow and integrity of data. This module may accommodate a wide range of data sources and formats to facilitate integration and communication within the machine learning architecture.

In an embodiment, an input handler within input/output module 120 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 120 to be versatile in different operational contexts, whether processing historical datasets or streaming data.

In accordance with an embodiment, input/output module 120 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 120 includes an output framework designed to handle the distribution and exportation of outputs, predictions, or insights. Using the output framework, input/output module 120 formats these outputs into user-friendly and accessible formats, such as reports, visualizations, or data files compatible with other systems. Input/output module 120 also ensures secure and efficient transmission of these outputs to end-users or other systems in an embodiment and may employ encryption and secure data transfer protocols to maintain data confidentiality.

In accordance with an embodiment, data preprocessing module 122 transforms data into a format suitable for use by other modules in machine learning engine 100. For example, data preprocessing module 122 may transform raw data into a normalized or standardized format suitable for training ML models and for processing new data inputs for inference. In an embodiment, data preprocessing module 122 acts as a bridge between the raw data sources and the analytical capabilities of machine learning engine 100.

In an embodiment, data preprocessing module 122 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 122 may be configured to handle anomalies in different ways depending on context. Data preprocessing module 122 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 122 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 122 processes new data for inference, data preprocessing module 122 replicates the same preprocessing steps to ensure consistency with the training data format. This helps to avoid discrepancies between the training data format and the inference data format, thereby reducing the likelihood of inaccurate or invalid model predictions.

In an embodiment, model selection module 124 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 124 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 124 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 124 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 124 also considers computational efficiency and resource constraints. This is meant to help ensure the selected model is both accurate and practical in terms of computational and time requirements. In an embodiment, certain features of model selection module 124 are configurable such as a configured bias toward (or against) computational efficiency.

In accordance with an embodiment, training module 126 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 126 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 126 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 126 includes logic to handle different types of data and learning tasks. For instance, it includes different training routines for supervised learning (where the training data comes with labels) and unsupervised learning (without labeled data). In the case of deep learning models, training module 126 also manages the complexities of training neural networks that include initializing network weights, choosing activation functions, and setting up neural network layers.

In an embodiment, evaluation and tuning module 128 incorporates dynamic feedback mechanisms and facilitates continuous model evolution to help ensure the system's relevance and accuracy as the data landscape changes. Evaluation and tuning module 128 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 128 performs continuous model tuning by using hyperparameter optimization. Evaluation and tuning module 128 performs an exploration of the hyperparameter space using algorithms, such as grid search, random search, or more sophisticated methods like Bayesian optimization. Evaluation and tuning module 128 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 128 integrates data feedback and updates the model. Evaluation and tuning module 128 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 128 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 128 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 130 transforms data raw data into actionable, precise, and contextually relevant predictions. In addition to processing and applying a trained model to new data, inference module 130 may also include post-processing logic that refines the raw outputs of the model into meaningful insights.

In an embodiment, inference module 130 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 130 transforms the outputs of a trained model into definitive classifications. Inference module 130 employs the underlying model as a tool to generate probabilistic outputs for each potential class. It then engages in an interpretative process to convert these probabilities into concrete class labels.

In an embodiment, when inference module 130 receives the probabilistic outputs from the model, it analyzes these probabilities to determine how they are distributed across some or every potential class. If the highest probability is not significantly greater than the others, inference module 130 may determine that there is ambiguity or interpret this as a lack of confidence displayed by the model.

In an embodiment, inference module 130 uses thresholding techniques for applications where making a definitive decision based on the highest probability might not suffice due to the critical nature of the decision. In such cases, inference module 130 assesses if the highest probability surpasses a certain confidence threshold that is predetermined based on the specific requirements of the application. If the probabilities do not meet this threshold, inference module 130 may flag the result as uncertain or defer the decision to a human expert. Inference module 130 dynamically adjusts the decision thresholds based on the sensitivity and specificity requirements of the application, subject to calibration for balancing the trade-offs between false positives and false negatives.

In accordance with an embodiment, inference module 130 contextualizes the probability distribution against the backdrop of the specific application. This involves a comparative analysis, especially in instances where multiple classes have similar probability scores, to deduce the most plausible classification. In an embodiment, inference module 130 may incorporate additional decision-making rules or contextual information to guide this analysis, ensuring that the classification aligns with the practical and contextual nuances of the application.

In regression models, where the outputs are continuous values, inference module 130 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 130 incorporates domain-specific adjustments into its post-processing routine. This involves tailoring the model's output to align with specific industry knowledge or contextual information. For example, in financial forecasting, inference module 130 may adjust predictions based on current market trends, economic indicators, or recent significant events, ensuring that the outputs are both statistically accurate and practically relevant.

In an embodiment, inference module 130 includes logic to handle uncertainty and ambiguity in the model's predictions. In cases where inference module 130 outputs a measure of uncertainty, such as in Bayesian inference models, inference module 130 interprets these uncertainty measures by converting probabilistic distributions or confidence intervals into a format that can be easily understood and acted upon. This provides users with both a prediction and an insight into the confidence level of that prediction. In an embodiment, inference module 130 includes mechanisms for involving human oversight or integrating the instance into a feedback loop for subsequent analysis and model refinement.

In an embodiment, inference module 130 formats the final predictions for end-user consumption. Predictions are converted into visualizations, user-friendly reports, or interactive interfaces. In some systems, like recommendation engines, inference module 130 also integrates feedback mechanisms, where user responses to the predictions are used to continually refine and improve the model, creating a dynamic, self-improving system.

FIG. 2 illustrates the operation of a machine learning engine in one or more embodiments. At step 1, input/output module 120 receives a dataset intended for training. This data can originate from diverse sources, like databases or real-time data streams, and in varied formats, such as CSV, JSON, or XML. Input/output module 120 assesses and validates the data, ensuring its integrity by checking for consistency, data ranges, and types.

At step 2, training data is passed to data preprocessing module 122. Here, the data undergoes a series of transformations to standardize and clean it, making it suitable for training ML models. This involves normalizing numerical data, encoding categorical variables, and handling missing values through techniques like imputation.

At step 3, prepared data from the data preprocessing module 122 is then fed into model selection module 124. This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

At step 4, training module 126 trains the selected model with the prepared dataset. It implements learning algorithms to adjust the model's internal parameters, optimizing them to identify patterns and relationships in the training data. Training module 126 also addresses the challenge of overfitting by implementing techniques, like regularization and early stopping, ensuring the model's generalizability.

At step 5, evaluation and tuning module 128 evaluates the trained model's performance using the validation dataset. Evaluation and tuning module 128 applies various metrics to assess predictive accuracy and generalization capabilities. It then tunes the model by adjusting hyperparameters, and if needed, incorporates feedback from the model's initial deployments, retraining the model with new data patterns identified from the feedback.

At step 6, input/output module 120 receives a dataset intended for inference. Input/output module 120 assesses and validates the data.

At step 7, data preprocessing module 122 receives the validated dataset intended for inference. Data preprocessing module 122 ensures that the data format used in training is replicated for the new inference data, maintaining consistency and accuracy for the model's predictions.

At step 8, inference module 130 processes the new data set intended for inference, using the trained and tuned model. It applies the model to this data, generating raw probabilistic outputs for predictions. Inference module 130 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 140 allows for applications to leverage machine learning engine 100. In an embodiment, machine learning engine API 140 may be built on a RESTful architecture and offer stateless interactions over standard HTTP/HTTPS protocols. Machine learning engine API 140 may feature a variety of endpoints, each tailored to a specific function within machine learning engine 100. In an embodiment, endpoints such as/submitData facilitate the submission of new data for processing, while/retrieveResults is designed for fetching the outcomes of data analysis or model predictions. The MLE API may also include endpoints like/updateModel for model modifications and/trainModel to initiate training with new datasets.

In an embodiment, machine learning engine API 140 is equipped to support SOAP-based interactions. This extension involves defining a WSDL (Web Services Description Language) document that outlines the API's operations and the structure of request and response messages. In an embodiment, machine learning engine API 140 supports various data formats and communication styles. In an embodiment, machine learning engine API 140 endpoints may handle requests in JSON format or any other suitable format. For example, machine learning engine API 140 may process XML, and it may also be engineered to handle more compact and efficient data formats, such as Protocol Buffers or Avro, for use in bandwidth-limited scenarios.

In an embodiment, machine learning engine API 140 is designed to integrate WebSocket technology for applications necessitating real-time data processing and immediate feedback. This integration enables a continuous, bi-directional communication channel for a dynamic and interactive data exchange between the application and machine learning engine 100.

### 3. Large Language Models

One type of ML model is a large language model. These models are designed to understand, generate, and interpret human language by processing extensive collections of data. The foundational architecture behind large language models is the transformer network, a type of neural network that excels in handling sequential data, such as text. Unlike architectures such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence, regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections so the model can focus on the most informative parts of the text.

In accordance with one or more embodiments, transformers are composed of multiple layers containing a multi-head self-attention mechanism and a position-wise feed-forward network. Within the architecture of transformer models, the multi-head self-attention mechanism and position-wise feed-forward network function in concert to process input data. The multi-head self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head self-attention mechanism is the position-wise feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence so the model can learn complex patterns across different parts of the input data without relying on the sequential processing inherent to previous architectures such as RNNs or LSTMs.

In accordance with one or more embodiments, integration of these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 120 when used for large language models handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 122 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 124, when used for large language models involves choosing a specific architecture and configuration that is best suited to the task at hand. This decision is based on factors such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 126 when used for large language models is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques such as dropout and layer normalization are used to improve model generalization and prevent overfitting (i.e., when a model learns the detail and noise in the training data to the extent that it negatively impacts the model's performance on new data).

In accordance with one or more embodiments, evaluation and tuning module 128 assesses the performance of large language models using metrics such as perplexity, accuracy, and F1 score, depending on the specific language tasks. Evaluation may involve comparing the model's output against a set of labeled validation data, providing insight into how well the model has learned to perform tasks such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 130 in the context of large language models is responsible for generating predictions or responses based on new, unseen data. This process involves feeding the input data through the trained model to produce an output. Inference can be used for a variety of applications, including translating text, generating human-like responses in a chatbot, or summarizing articles.

### 4. Output Evaluation—Deterministic Computational Metrics

In accordance with one or more embodiments, system-generated deterministic computational metrics may be used to achieve a variety of scores associated with the output of a ML model such as a large language model. Computational metrics, as described herein, are generated by deterministic models. Deterministic models operate under a set of predefined rules or mathematical formulas that produce the same output every time given the same input. The result is that there is no variation in their response to the same set of circumstances. These models include algorithms that calculate distances, perform specific transformations, or apply logic that does not change unless the model itself is altered. The predictability and repeatability of deterministic models make them valuable for tasks requiring efficiency and consistent outcomes. Metrics generated from deterministic models may be referred to herein as deterministic metrics, computational metrics, or system-generated deterministic computational metrics.

In accordance with one or more embodiments, a variety of deterministic models may be used to generate metrics that can be used to describe certain features of a ML model. Some of these metrics models fall into the following categories. Surface-Level Overlap Metrics measure the overlap of n-grams, words, or sequences between the generated text and reference texts, focusing on exact matches. Semantic similarity metrics use embeddings from pre-trained language models to calculate the semantic similarity between generated and reference texts, considering contextual meanings. Generative model-based metrics assess text quality by using pre-trained generative models to evaluate the likelihood or plausibility of the generated text in comparison to the reference text. Embedding-based similarity metrics employ various word or sentence embedding models to compute the distance between the embeddings of generated and reference texts, reflecting semantic closeness. Linguistic quality metrics focus on the linguistic and stylistic aspects of generated text, such as grammar, coherence, and style, often using specialized computational tools for analysis. This is not an exhaustive list of the types of metrics that may be used to analyze output of large language models, and other deterministic models may be used to generate computational metrics that may be used in an embodiment. Some example metrics (scores) are discussed below.

The ROUGE score, standing for Recall-Oriented Understudy for Gisting Evaluation, is a set of metrics used for evaluating automatic summarization and machine translation software in natural language processing. The core idea behind ROUGE is to compare an automatically generated summary or translation against one or more reference summaries or translations. This comparison is primarily focused on the overlap of content between the machine-generated and reference texts. The overlap is measured in terms of n-grams, word sequences, and in some variations, word pairings or longest common subsequences.

The calculation of ROUGE involves several variations, each designed to capture different aspects of similarity. ROUGE-N, for example, measures the overlap of n-grams between the generated text and the reference texts. It calculates recall by dividing the number of overlapping n-grams in the generated text by the number of n-grams in the reference text. Precision can also be measured by dividing the number of overlapping n-grams in the generated text by the number of n-grams in the generated text itself. F-measure can then be calculated from the precision and recall to provide a harmonic mean.

Another variant, ROUGE-L, uses the longest common subsequence to assess the similarity between texts. It evaluates the longest sequence of words that appears in both the generated and reference texts, considering the sequence's order but not requiring consecutive words. This allows for the evaluation of text similarity at a more structural level, reflecting the coherence and flow of content.

ROUGE scores are used as a quantitative measure to assess the performance of systems in producing summaries or translations that are close to human-generated references. They serve as a benchmark for comparing different systems or for measuring improvements within the same system over time. However, while ROUGE provides valuable metrics, it is acknowledged that it cannot fully capture the qualitative aspects of text generation, such as readability, coherence, and relevance, necessitating supplementary qualitative evaluations.

The BLEU score, or Bilingual Evaluation Understudy, is a metric for evaluating the quality of text that has been machine-translated from one language to another. It quantifies the correspondence between a machine's output and that of a human, focusing primarily on the accuracy of content translation at the level of words and phrases. BLEU operates by comparing the n-grams of the machine-translated text to the n-grams of reference translations and counts the number of matches. These matches are then adjusted for the proper length to avoid favoring overly short or long translations.

The calculation of the BLEU score involves a few key steps. First, it computes the precision of n-grams (up to a limit, typically four) by dividing the number of n-gram matches by the total number of n-grams in the machine translation. However, to prevent the exploitation of this measure through excessive use of common short phrases, BLEU applies a brevity penalty. This penalty compares the length of the machine translation to the length of the reference translations, penalizing translations that are too short compared to the closest reference length. The overall BLEU score is then calculated as the geometric mean of the n-gram precision scores, multiplied by the brevity penalty.

The BLEU score is widely used in the field of natural language processing to evaluate and benchmark the performance of machine translation systems. It provides a quantitative measure that facilitates the comparison of different translation models or the progress of a single model over time. Despite its widespread adoption, BLEU has limitations, particularly in its ability to fully capture the semantic accuracy and fluency of translations. It primarily assesses the presence of correct phrases and their sequences, rather than the quality of the overall translation or the contextual appropriateness of the output.

BertScore is an evaluation metric for natural language processing that leverages the contextual embeddings from BERT (Bidirectional Encoder Representations from Transformers) or similar transformer-based models to assess the quality of text generation tasks, such as machine translation, summarization, or data-to-text generation. Unlike traditional metrics that rely on exact matches of n-grams between the generated text and reference texts, BertScore computes semantic similarity using contextual embeddings, offering a more nuanced understanding of text similarity.

The calculation of BertScore involves several steps. First, it generates embeddings for each token in the candidate text and the reference text using a pre-trained BERT model. These embeddings capture the contextual meaning of each word within its sentence. Next, BertScore computes the cosine similarity between each token in the candidate text and every token in the reference text. For each token in the candidate text, it identifies the maximum similarity score with any token in the reference text, and vice versa. These similarity scores are then aggregated to produce precision, recall, and F1 scores at the token level. Precision is calculated by averaging the maximum similarity scores of tokens in the candidate text with respect to the reference tokens. Recall is calculated similarly but averages the maximum similarity scores of tokens in the reference text with respect to the candidate tokens. The F1 score is the harmonic mean of precision and recall, providing a single measure that balances both.

BertScore is used for evaluating the semantic and contextual quality of generated texts in comparison to one or more reference texts. It addresses some limitations of traditional metrics by accounting for the meanings of words in context, making it better suited for tasks where paraphrasing, word order variations, and other subtleties in language use are significant. Despite its advantages in capturing semantic similarities, BertScore depends on the quality of the underlying BERT or transformer model embeddings and may reflect biases present in these pre-trained models.

MoverScore is a metric for evaluating the similarity between two texts in the context of natural language processing tasks, such as machine translation, text summarization, and text generation. It extends the concept of Word Mover's Distance (WMD) by utilizing contextual embeddings from pre-trained transformer models like BERT, to measure the semantic distance between words in the candidate and reference texts. This approach allows MoverScore to capture deeper semantic meanings and nuances beyond surface-level word matches.

The calculation of MoverScore involves several steps. Initially, contextual embeddings are generated for words in both the candidate and the reference texts using a transformer-based model. These embeddings represent words in the context of their surrounding text, thus capturing their meaning more accurately than static word embeddings. MoverScore then computes the pairwise distance between each word in the candidate text and each word in the reference text using these embeddings, typically employing cosine distance as the metric.

The core of MoverScore's calculation is the optimization problem solved by the Earth Mover's Distance (EMD) algorithm. The EMD algorithm finds the minimum cumulative distance that words in the candidate text need to “travel” to match the words in the reference text. This is conceptualized as moving a pile of earth to match another pile, where the piles represent word distributions in embedding space, and the effort to move them reflects their semantic distances. The resulting score is a measure of this minimum effort, normalized to account for differences in text lengths and to provide a bounded similarity score.

MoverScore is used to evaluate how well the content of a generated text matches a reference text in terms of meaning and relevance, rather than relying solely on exact word matches or syntactic similarity. This makes it particularly suited for tasks where paraphrasing, flexible word order, and nuanced expression are common. By leveraging the contextual understanding provided by transformer models, MoverScore offers a sophisticated measure of textual similarity that aligns more closely with human judgments of textual quality and semantic equivalence. However, the performance of MoverScore is inherently tied to the quality of the underlying model embeddings and the computational complexity of the EMD calculation. The EMD calculation can be substantial for longer texts.

PRISM, or Paraphrase Representations from Image Search Models, is a metric for evaluating machine-generated text against reference texts within the domain of natural language processing (NLP). Unlike traditional metrics that rely heavily on lexical overlap or embeddings-based semantic similarity, PRISM leverages a pre-trained neural machine translation (NMT) model to estimate the likelihood of a reference translation given a machine-generated translation. This approach is grounded in the concept of translation quality estimation (QE), where the metric evaluates the quality of text without relying on direct comparisons to a reference text.

The calculation of the PRISM score involves using a large, multilingual NMT model that has been trained on a diverse set of languages and translation tasks. When presented with a candidate text and a reference text, PRISM treats the candidate text as a translation of the reference text and uses the NMT model to compute the probability of the candidate text being a plausible translation of the reference. This process inherently captures not only lexical and syntactic similarity but also semantic coherence and fluency, as the NMT model's training on translation tasks equips it to evaluate the quality of translation-like outputs.

PRISM is utilized in various NLP tasks, including machine translation, summarization, and data-to-text generation, to assess the quality of generated texts. Its unique approach allows it to measure how naturally a machine-generated text corresponds to a given reference text, moving beyond mere word overlap to assess deeper aspects of language use such as adequacy and fluency. The model's ability to consider the broader context and semantic content of texts makes it a valuable tool for evaluating the performance of NLP systems, especially in scenarios where traditional metrics may fall short due to their inability to fully capture the nuances of human language.

BARTScore is an evaluation metric designed for assessing the quality of text generated by natural language processing (NLP) models. It is based on the BART (Bidirectional and Auto-Regressive Transformers) model. The BART model is a transformer-based ML model known for its effectiveness in text generation and comprehension tasks. BARTScore leverages the capabilities of BART to evaluate the similarity and relevance of a generated text with respect to a reference text, focusing on both the content and the fluency of the text.

The core mechanism of BARTScore involves using the BART model to compute the likelihood of generating the reference text given the generated text as input (or vice versa), essentially treating the evaluation as a conditional text generation problem. This process entails calculating the probability of the reference text conditioned on the generated text, according to the model's learned distribution over possible texts. The score is derived from these conditional probabilities, with higher scores indicating a greater degree of similarity and coherence between the generated text and the reference text, as judged by the BART model's internal representations.

BARTScore is applied in various NLP evaluation tasks, such as summarization, machine translation, and text generation, to quantify how well the generated text aligns with the target or reference text in terms of both meaning and linguistic quality. Unlike traditional metrics that might rely on surface-level overlaps (e.g., n-gram matching) or semantic embeddings, BARTScore utilizes the deep contextual understanding and generative capabilities of the BART model to assess the quality of text output in a more nuanced and comprehensive manner. This approach allows BARTScore to capture aspects of text quality, including semantic fidelity and fluency, that are used for evaluating the performance of advanced NLP systems. All of the computational metrics discussed above are fundamentally mathematically and statistically computed. They rely on mathematical formulas and statistical methods to analyze text features, similarities, and differences. These metrics apply mathematical operations to quantify aspects of text such as similarity, readability, and quality. For example, calculating the average sentence length, word length, or the cosine similarity between vector representations of text falls under mathematical computation. These metrics often involve statistical analysis, particularly when dealing with probabilities (as in generative model-based metrics), distributions of words or phrases, or when aggregating individual scores to derive a summary evaluation of text quality. These metrics are deterministic. Given the same input (generated text and reference text), they will produce the same score every time, based on their mathematical or statistical formulas. The underlying models they rely on, especially in the case of semantic similarity and generative model-based metrics, may incorporate elements of randomness during their training phase, but the evaluation process itself is deterministic when applying these metrics because the model is frozen at that point.

### 5. Output Evaluation—Qualitative Metrics

In accordance with one or more embodiments, human evaluation of model output may be used to measure the quality of the model output. Human evaluations in machine learning, particularly in natural language processing, involve subjective assessment by individuals to rate or judge the quality of machine-generated outputs on aspects such as coherence, relevance, fluency, and overall acceptability. This method contrasts with deterministic, quantitative metrics by incorporating human judgment to capture nuances of language that automated metrics may not fully address. These evaluations are qualitative, relying on the perception and cognitive judgment of evaluators, and are structured through methods such as Likert scales, pairwise comparisons, or open-ended feedback to gather insights on the text generated by models.

The process of conducting human evaluations involves significant resources and planning. The expense associated with human evaluations encompasses not only the direct costs of compensating evaluators but also the indirect costs related to the time and infrastructure needed to collect, process, and analyze the qualitative data obtained from such assessments. Despite the challenges and resources required, human evaluations are highly desirable for assessing the performance of machine learning systems. This perspective is based on the understanding that human judgment can capture the complexity and variability of language. Human evaluators may provide insights into the quality of machine-generated text, particularly in terms of its alignment with human perceptions of naturalness and appropriateness for the context.

In accordance with one or more embodiments, human quality scores for evaluating machine-generated text in natural language processing tasks may be provided as aggregated results from various subjective assessment methods. The subjective assessment metrics may be aimed at capturing different dimensions of text quality as perceived by human evaluators. These scores can take various forms, depending on the assessment methodology employed. For example, Likert scale assessments yield numerical scores that reflect the degree of agreement or satisfaction with specific attributes of the text, such as coherence, fluency, relevance, and engagement. Scores from individual evaluators are aggregated to produce average scores for each attribute, offering a quantitative representation of qualitative judgments. For instance, a coherence score might average at 4.2 out of 5, indicating generally high coherence as judged by the evaluators. As another example, pairwise comparisons may also be used. In pairwise comparisons, evaluators choose between two options based on a given criterion. The outcomes of the pairwise comparisons can be tallied to rank multiple text segments according to their perceived quality. This ranking system helps to identify which texts are consistently preferred over others, providing a relative measure of quality across a set of generated texts. Many other methods of obtaining and presenting human feedback may be used in one or more embodiments.

In accordance with one or more embodiments, a large language model may be used to provide a qualitative evaluation of model output. For example, a generative large language model that uses significant resources may be used to evaluate the output of a different large language model that uses fewer resources. The output to be analyzed may be presented to the large language model along with questions that would be provided to a human evaluator. The resulting scores may be presented in the same way, or in a different way than a score resulting from human evaluation.

An evaluation conducted by a large language model is qualitative because of the methodologies it employs for analyzing and interpreting text. These methodologies are rooted in semantic understanding and contextual analysis rather than numerical measurement. LLMs leverage training on vast amounts of text to generate assessments based on the meaning, coherence, and relevancy of the content in question. This process involves parsing the syntactic structures and extracting the semantic relationships within the text, tasks that inherently require a qualitative approach.

In addition, an evaluation conducted by a large language model is not deterministic because he inherent probabilistic nature of its underlying algorithms and the variability introduced by its training and operational parameters. LLMs, particularly those based on transformer architectures, generate outputs by calculating conditional probability distributions over a sequence of tokens, where the selection of subsequent tokens during text generation involves stochastic sampling methods. This process, influenced by mechanisms such as temperature scaling or top-k sampling, introduces an element of randomness in the output generation, leading to variability in the evaluations produced for the same input under identical conditions.

### 6. Output Evaluation Agent Architecture

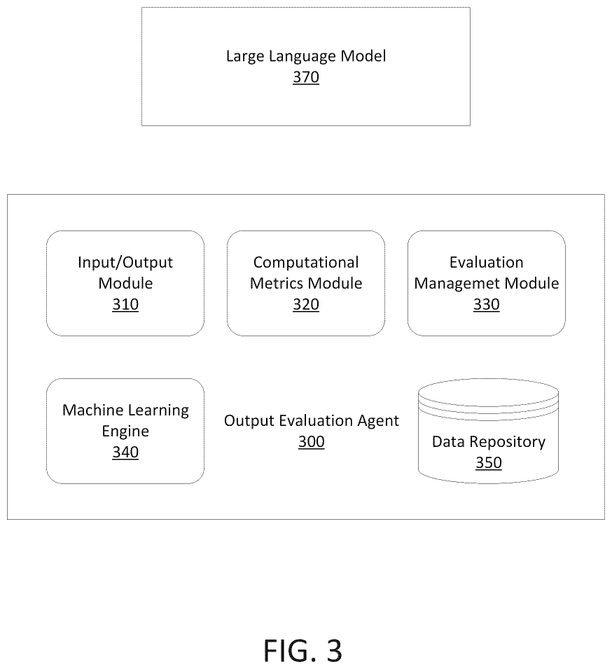

FIG. 3 illustrates an output evaluation agent 300 in accordance with one or more embodiments. As illustrated in FIG. 3, output evaluation agent includes input/output module 310, computational metrics module 320, evaluation management module 330, machine learning module 340, and data repository 350. FIG. 3 includes large language module 370.

In accordance with one or more embodiments, large language module 370 incorporates characteristics discussed in section 3, generally relating to large language models. Large language model 370 receives input that may be in the form of text from a user, for example, and generates output. One or more embodiments perform an analysis on the output of large language model 370. The output of large language model 370 may be used to generate computational deterministic metrics and may also be used to generate qualitative metrics in accordance with one or more embodiments.

In accordance with one or more embodiments, input/output module 310 serves as the primary interface for data entering and exiting output evaluation agent 300, managing the flow and integrity of data. This module may accommodate a wide range of data sources and formats to facilitate integration and communication with users, large language model 370, and other systems. For example, input/output module 310 manages the collection of output, prompt information, and other metadata from large language model 370. Input/output module 310 also manages communication with data repository 350 if data repository 350 is external to output evaluation agent 300.

In an embodiment, an input handler within input/output module 310 includes a data ingestion framework capable of interfacing with various data sources, such as databases, APIs, and file systems. This framework is equipped with functionalities to handle different data formats (e.g., CSV, JSON, XML) and efficiently manage large volumes of data. It includes mechanisms for batch and real-time data processing that enable the input/output module 310 to be versatile in different operational contexts, whether processing historical datasets or real-time data from large language model 370.

In accordance with an embodiment, input/output module 310 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the output evaluation process.

In an embodiment, an output handler within input/output module 310 includes an output framework designed to manage the distribution and exportation of outputs. Using the output framework, input/output module 310 formats these outputs into user-friendly and accessible formats, such as reports, visualizations, or data files compatible with other systems. Input/output module 310 also ensures secure and efficient transmission of these outputs to end-users or other systems in an embodiment and may employ encryption and secure data transfer protocols to maintain data confidentiality.

In accordance with one or more embodiments, computational metrics module 320 functions as the analytical engine that applies mathematical and statistical methodologies to assess the output from large language model 370. Computational metrics module 320 receives processed text outputs from input/output module 310. Input/output module 310 handles the basic interactions with large language model 370 and applies a series of predefined algorithms to compute various scores that quantify aspects of text quality such as semantic similarity, coherence, and relevance to reference texts.

In accordance with one or more embodiments, computational metrics module 320 is structured to interface with text outputs and reference materials, organizing them in a manner suited for analysis. For each metric, the module extracts the necessary elements from the text such as n-grams for BLEU and ROUGE scores, or embeddings for metrics like BertScore. Any other relevant linguistic features required by the specific evaluation criteria being applied are extracted from the text by computational metrics module 320. For example, in the case of BLEU score computation, the module segments the text into n-grams and calculates the precision of these n-grams in comparison to those in the reference text, adjusting for sentence length to prevent bias towards shorter texts. Similarly, for metrics like BertScore, the module utilizes pretrained embeddings to represent the text and reference materials, computing cosine similarity scores between these embeddings to assess semantic coherence and alignment.

In accordance with one or more embodiments, computational metrics module 320 integrates algorithms for normalization and weighting of scores if output evaluation module is configured to do so or if applicable based on score type. This helps to ensure that the final scores are comparable across different texts and contexts. This involves, for example, applying a brevity penalty in BLEU score calculation or calculating the harmonic mean of precision and recall in ROUGE score to derive the F1 measure.

In accordance with one or more embodiments, the output of the computational metrics module 320 is a structured set of scores for each text evaluated. computational metrics module 320 may be configured to provide more than one score for some algorithms and may be configured to calculate a variety of metrics associated with the output of a large language model. In accordance with one or more embodiments, the scores generated by computational metrics module are deterministic quantitative metrics, and not qualitative metrics.

In accordance with one or more embodiments, machine learning engine 340 may comprise components that are the same as, or similar to, the components of machine learning engine 100. Machine learning engine 340 may also perform operations in a similar manner to machine learning engine 100.

In accordance with one or more embodiments, machine learning engine 340 is configured to receive as input training data that includes a set of metrics for a different ML model such as large language model 370. The metrics may include both computational deterministic metrics and qualitative metrics, both associated with output of a large language model. For example, the set of metrics may include computational metrics such as a BLEU score or ROUGE score, and BertScore, each associated with the same output from a large language model. The metrics may also include qualitative metrics, such as human-generated metrics or metrics generated by another large language model. Machine learning engine is configured to train ML models to predict qualitative metrics based on computational deterministic metrics using the data set.

In accordance with one or more embodiments, machine learning engine 340 is configured to receive computational metrics from computational metrics module 320 as input. Machine learning engine 340 learning engine 340 is configured to generate a set of estimated qualitative metrics using a trained model. In an embodiment, machine learning engine may use more than one model to generate a set of estimated qualitative metrics based on the same set of computational metrics.

In accordance with one or more embodiments, evaluation management module 330 is configured with logic to evaluate the effectiveness of different models. For example, in some cases a neural network may be more effective than a statistical model for generating estimated qualitative metrics based on a set of computational metrics. However, a statistical model may prove to be less accurate than a neural network, but may result in the use of less resources than a neural network. Evaluation management module 330 may be configured with threshold logic that defines an acceptable trade-off between accuracy and performance. One way to configure evaluation management module 330 is to define minimum requirements for both resource usage and accuracy. If both are met, then a model that uses fewer resources may be selected. In accordance with one or more embodiments, a variety of triggers may be incorporated into the threshold logic to ensure the most desirable model is selected.

In accordance with one or more embodiments, evaluation management module 330 is configured to work with machine learning engine 340 to test a set of models. Evaluation management module 330 may be configured to automate the training and testing of a selection of models or model types. For example, evaluation management module 330 may be configured to test both a neural network and a statistical model for a given data set. The most effective model, as defined in the configuration of evaluation management module 330, will be selected for use in the evaluation of output from large language model 370.

In accordance with one or more embodiments, evaluation management module 330 is configured to compare outcomes from different data sets to determine the value of collecting and using certain types of data. For example, collecting human evaluation data may be too expensive or may be associated with certain restrictions that make it difficult to collect human evaluation data. In an embodiment, evaluation management module may be configured to determine whether substitute evaluation data from an advanced generative large language model may be used, instead of genuine human evaluations, to train the neural network (or statistical model).

In accordance with one or more embodiments, data repository 350 is any type of storage unit and/or device (e.g., a file system, database, collection of tables, or any other storage mechanism) for storing data. Further, a data repository 350 may include multiple different storage units and/or devices. The multiple different storage units and/or devices may or may not be of the same type or located at the same physical site. Further, a data repository 350 may be implemented or executed on the same computing system as output evaluation agent 300. Additionally, or alternatively, a data repository 350 may be implemented or executed on a computing system separate from output evaluation agent 300. The data repository 350 may be communicatively coupled to output evaluation agent 300 via a direct connection or via a network.

In accordance with one or more embodiments, data repository 350 may be used to store data received from large language model via input/output module 310. Data repository 350 may also be used to store computational metrics generated by computational metrics module 320, or qualitative metrics generated by human input or by machine learning engine 340. data repository 350 may also store other information generated by evaluation management module 330 or received via input/output module 310.

In an embodiment, output evaluation agent 300 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, a user interface in hardware and/or software configured to facilitate communications between a user and output evaluation module 300. The user interface renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of the user interface are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, the user interface is specified in one or more other languages, such as Java, C, or C++.

### 7. Evaluating ML Model Output

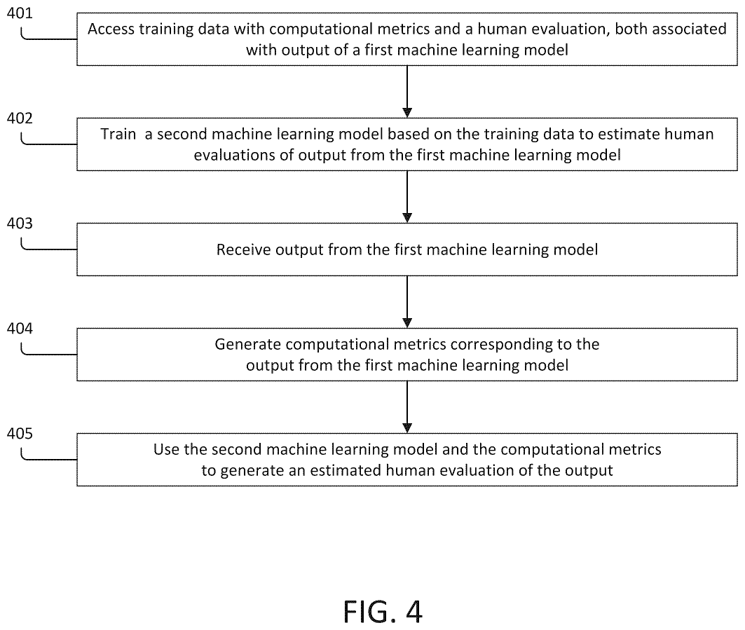

FIG. 4 illustrates an example set of operations for evaluating ML model output in accordance with one or more embodiments. One or more operations illustrated in FIG. 4 may be modified, rearranged, or omitted entirely. Accordingly, the sequence of operations illustrated in FIG. 4 should not be construed as limiting the scope of one or more embodiments.

In accordance with one or more embodiments, output evaluation agent 300 accesses, via input/output module 310, training data that includes one or more computational metrics and a human evaluation, both associated with output of a target ML model (Operation 401). For example, the computational metrics may include metrics such as a BLEU score, a BertScore, a ROUGE score, and other scores for an output. These scores each provide metrics that measure certain aspects of the output of the target ML model by leveraging deterministic models trained specifically for the purpose of generating the type of score the model is associated with.

In accordance with one or more embodiments, the human evaluation may include a single metric that represents the overall quality of the target ML model output. In other embodiments, the human evaluation may include more than one qualitative metric, each describing the quality of a different attribute of the target ML model output.

For example, assessments may be structured to incorporate multiple qualitative metrics, each targeting a specific characteristic of the target ML model output such as coherence, fluency, relevance, factual accuracy, and engagement. This delineation enables a detailed analysis of the model's performance on different linguistic and content-related dimensions. Evaluators apply predefined scales for each attribute. For example, Likert scales may be used to rate fluency and relevance, while checklists could assess factual accuracy. In an embodiment, the aggregation of these attribute-specific assessments into a composite score may involve weighted sums, where weights are assigned based on the predetermined importance of each attribute to the overall quality of the text. In another embodiment, no aggregation is used, resulting in a mapping of multiple computational metrics calculated by machine to multiple qualitative metrics determined by humans.

In accordance with one or more embodiments, the computational metrics and the human evaluation are stored in data repository 350. The computational metrics and the human evaluation are mapped to one another in a data set to indicate that they are associated with the same ML model output. For example, each line in a data set (such as a database table, flat file, or other data storage managed by data repository 350) may include one or more computational (deterministic) metrics and one or more human evaluation (qualitative) metrics. Many lines may exist in a data set of such metrics, showing different computational and qualitative outcomes for different target ML model output.

In accordance with one or more embodiments, additional information may be included in the data set. For example, the actual output from the target ML model may be included in the data set. Context associated with the data set may also be included (e.g., the type of application being used or the purpose for which the target ML model is being used). In one or more embodiments, the prompt presented to the target ML model may also be included in the data set.

In accordance with one or more embodiments, outcome evaluation agent 300 uses machine learning engine 340 to train an evaluation ML model, based on the training data, to estimate human evaluations of output from the target ML model (Operation 402). For example, the target ML model may be a generative large language model such as large language model 370, and the evaluation ML model may be a neural network managed by machine learning engine 340. The neural network is trained, using the data set accessed in Operation 401, to estimate human evaluations of output, or human evaluations of the system-generated computational metrics, from the generative large language model.

In accordance with one or more embodiments, in the process of training a neural network to map computational metrics to estimated human evaluation metrics, the output evaluation agent initiates by accessing the training data set. The training data set contains pairs of computational metrics as input features and human evaluation metrics as target outputs. The neural network is composed of layers of nodes, or neurons, with the initial layer receiving computational metrics as input, intermediate layers processing the inputs through various transformations, and the final layer producing the network's prediction of estimated human evaluation metrics.

In accordance with one or more embodiments, machine learning engine 340 begins training by feeding the computational metrics into the neural network. Each neuron in the initial layer processes these inputs and passes the metrics to the next layer through connections that have associated weights and biases that the network adjusts to learn the mapping. The data flow continues through the network until it reaches the output layer. The output layer generates the initial prediction of estimated human evaluation metrics.

In accordance with one or more embodiments, machine learning engine 340 evaluates the accuracy of predictions. Machine learning engine 340 computes the loss, a metric quantifying the difference between the predicted/estimated human evaluation metrics and the actual human evaluation metrics from the training data. The objective of training is to minimize this loss. Minimization of loss indicates that the network's predictions are becoming increasingly accurate. In an embodiment, minimization of the loss is achieved through an optimization algorithm such as gradient descent. For example, machine learning engine 340 may compute the gradient of the loss function with respect to each weight and bias in the network, utilizing backpropagation to calculate gradients by propagating the error back through the network from the output layer to the input layer.

In accordance with one or more embodiment, based on calculated gradients, machine learning engine 340 adjusts weights and biases to reduce the loss. This adjustment is done iteratively, and the training dataset is processed in batches. After each iteration, machine learning engine 340 evaluates the performance of the neural network on a separate validation set not seen during training to monitor for overfitting (i.e., learning the training data well and performing poorly on new data). This iterative process of forward propagation (feeding computational metrics through the network to get estimated human evaluation metrics), computing the loss, and backpropagation (adjusting weights and biases to minimize the loss) continues until the loss converges to a minimum value or a predefined number of iterations is reached.

In accordance with one or more embodiments, once the evaluation ML model (the neural network) has been trained, the output evaluation agent may use the evaluation ML model to make predictions (i.e., to generate estimated human evaluation metrics) related to output from the large language model based on computational metrics. To ensure that the computational metrics are available for use, the computational metrics module 320 generates the computational metrics based on output from the large language model.

In an embodiment, the output evaluation module receives output from the large language model, i.e., the target ML model (Operation 403). Output from the large language model may include text completions, answers to questions, generated summaries, translations, and other forms of natural language processing outputs. In an embodiment, output evaluation agent 300 can refine these outputs through further processing, such as applying specific formatting rules, filtering for desired content, or integrating with other data sources to enrich the provided information.

In accordance with one or more embodiments, the computational metrics module 320 generates computational metrics corresponding to the output from the target ML model (Operation 404). For example, the computational metrics module 320 may calculate BLEU scores for translation accuracy, ROUGE scores for summarization quality, and other scores that serve different purposes. Each metric offers a unique perspective on the output quality, focusing on different aspects such as lexical similarity, recall of essential information, and semantic accuracy.

In accordance with one or more embodiments, the computational metrics module 320 accesses configuration information to determine the computational metrics to generate. Configuration information may identify a set of scored to generate based on application context or other information related to the output. For example, computational metrics module 320 may be configured to generate a subset of available computational metrics if the context of the large language model output indicates that the output is associated with queries related to scientific studies. Each context may be associated with a different set of computational metrics in an embodiment, and a default set of computational metrics may be configured for contexts that are not associated with a configuration.

In accordance with one or more embodiments, the output evaluation agent uses the evaluation ML model (e.g., the neural network discussed above) and the computational metrics to generate an estimated human evaluation of the output from the large language model (Operation 405). Machine learning engine 340 inputs the computational metrics generated by computational metrics module 320 into the evaluation ML model. The evaluation ML model generates, as output, an estimated human evaluation. The estimated human evaluation includes qualitative metrics like or the same as metrics in the training data set in an embodiment.

In accordance with one or more embodiments, a training data set may include output from a generative large language model configured to provide qualitative evaluations in addition to or instead of human evaluations. This may be useful in situations where obstacles prevent the collection of enough qualitative data from humans. For example, collecting enough human evaluations to train a neural network well enough to make predictions with low error rates may be cost prohibitive. As another example, confidentiality or privacy considerations may make collection of human evaluations undesirable.

In accordance with one or more embodiments, to train a neural network or statistical model to generate evaluations of the output of a target large language model, output evaluation agent 300 may generate a training data set using a next-generation large language model. For example, a generative large language model that is more sophisticated than the target large language model may generate evaluations as good as or nearly as good as humans. Using a next-generation generative large language model to review the quality of large amounts of output from the target large language model may be cost prohibitive, so training a neural network to create similar qualitative metrics may be preferred. In accordance with one or more embodiments, a neural network may be trained using a data set that includes both computational deterministic metrics and qualitative metrics generated by the more advanced large language model.

In accordance with one or more embodiments, rather than generating estimated human evaluations as discussed above, the trained neural network (or statistical model) will generate estimated large language model output based on the computational metrics provided as input. This serves to generate qualitative metrics similar to qualitative metrics that the next-generation large language model would provide if given the same input, but rather than basing the estimated metric generation on the output directly, the estimated large language model metrics are generated based on the computational deterministic metrics.

In accordance with one or more embodiments, output evaluation agent 300 accesses a training data set that includes a mapping between a set of system-generated deterministic computational metrics corresponding to output of a target large language model (or other ML model) and a qualitative evaluation of the output of the target large language model. In an embodiment, the qualitative evaluation in the training data set may be generated by a next-generation large language model that is different from the large language model that generated the output being evaluated. Other information, such as metadata, context, or other evaluation types may be included in the training data set.

In accordance with one or more embodiments, the training set is used by machine learning engine 340 to train a ML model, such as a neural network or statistical model, to generate estimated qualitative evaluations of the output generated by the target large language model. In accordance with one or more embodiments, multiple models may be trained using the training data for later comparison with one another. In an embodiment, both a neural network and a statistical model are trained to generate estimated qualitative evaluations of the output generated by the target large language model, using system-generated deterministic computational metrics as input.

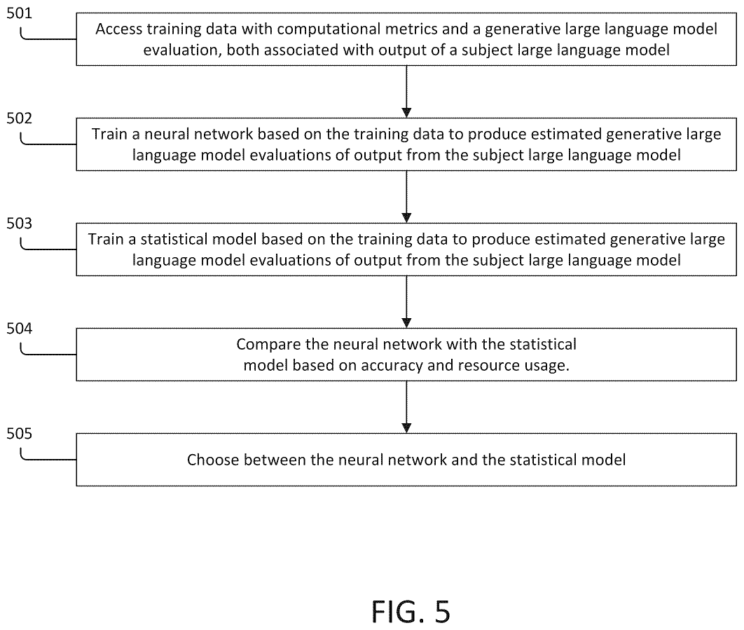

FIG. 5 illustrates an example set of operations for comparing ML models that are trained to evaluate output from a different ML model in accordance with one or more embodiments. One or more operations illustrated in FIG. 5 may be modified, rearranged, or omitted entirely. Accordingly, the sequence of operations illustrated in FIG. 4 should not be construed as limiting the scope of one or more embodiments.

In accordance with one or more embodiments, output evaluation agent 300 accesses, via input/output module 310, training data with computational metrics and a generative large language model evaluation, both associated with output of a subject large language model (Operation 501). For example, the computational metrics may include metrics such as a BLEU score, a BertScore, a ROUGE score, and other scores that measure aspects of large language model output. In an embodiment, the generative large language model evaluation may include a single metric that represents the overall quality of the ML model output. In other embodiments, the generative large language model evaluation may include more than one qualitative metric, each describing the quality of a different attribute of the ML model output. The metrics may be the same or similar to the metrics used for a human qualitative evaluation.

In accordance with one or more embodiments, machine learning engine 340 trains a neural network, based on the training data, to produce estimated generative large language model evaluations of output from the subject large language model (Operation 502). Training is performed in the same manner discussed previously with respect to training neural networks. Machine learning engine 340 feeds the computational metrics into the neural network, and adjusts weights and biases associated with neurons until the data flow reaches the output layer.

In accordance with one or more embodiments, machine learning engine 340 trains a statistical model, based on the training data, to produce estimated generative large language model evaluations of output from the subject large language model (Operation 503). When training a statistical model to predict generative large language model evaluation metrics from system-generated deterministic computational metrics, computational metrics module 320 uses a variety of mechanisms to evaluate and refine the model's performance. For example, for regression tasks, it utilizes Mean Squared Error (MSE) and Root Mean Squared Error (RMSE) to assess the accuracy of continuous predictions, guiding adjustments to minimize prediction errors. In classification tasks, the computational metrics module 320 considers Accuracy, Precision, Recall, F1-Score, and the Area Under the Receiver Operating Characteristic curve (AUROC) to evaluate the model's effectiveness in categorizing outcomes, balancing the precision of positive predictions against the ability to identify relevant instances.

Throughout the training process, these metrics serve as benchmarks for the computational metrics module 320, enabling iterative optimization of model parameters. This approach includes dividing the dataset into training and validation sets, using the former to fit the model and the latter to assess its generalization capabilities. By focusing on reducing overfitting and improving predictive accuracy, computational metrics module 320 ensures the statistical model reliably maps system-generated deterministic computational metrics to generative large language model evaluation metrics, adapting the model based on quantitative feedback to enhance its performance across various tasks.

In accordance with one or more embodiments, evaluation management module 320 compares the neural network with the statistical model based on accuracy and resource usage (Operation 504). As discussed above in connection with training neural networks and statistical models, error rates are determined during the training process, and may be expressed in terms of percentages. For example, one model (e.g., the neural network) may have a 5% error rate and another (e.g., the statistical model) may have a 7% error rate. Although low error rates may be desirable, evaluation management module 330 may be configured with a bias toward using models expending fewer resources. For example, if the expenditure of 3000% more resources results in only a 2% increase in accuracy, the model using fewer resources may be selected, even though it is less accurate than another model such as a neural network.

In accordance with one or more embodiments, evaluation management module chooses between the neural network and the statistical model (Operation 505). In an embodiment, evaluation management module 330 may be configured to select the model with the lowest resource utilization, so long as a certain accuracy threshold is met. In another embodiment, evaluation management module 330 may be configured to select the most accurate model that satisfies a maximum resource usage threshold. Any combination of rules may be used to configure output evaluation agent 300 in an embodiment, including configurations that balance resource utilization with accuracy. The selected model may be used for estimating large language model evaluations in an embodiment, given system-generated computational deterministic metrics as input.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 9. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

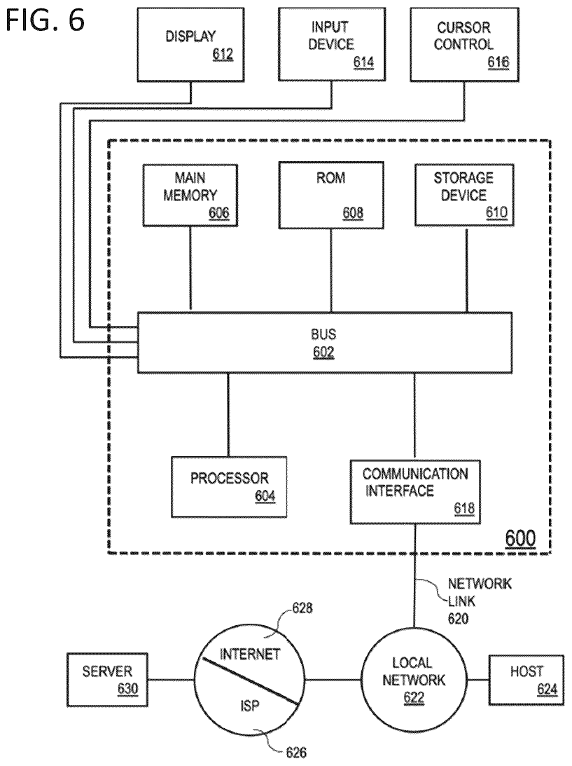

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 10. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
accessing a first training data set, wherein the first training data set comprises:
a set of system-generated computational metrics corresponding to a first output of a first ML model;
a human evaluation of the first output of the first ML model;
training a second ML model, based at least in part on the first training data set, to estimate human evaluations of output from the first ML model;
receiving a target output generated by the first ML model;
executing a machine-evaluation of the target output to generate a first set of system-generated computational metrics corresponding to the target output; and
applying the second ML model to the first set of system-generated computational metrics to generate a first estimated human evaluation of the target output.

2. The computer readable media of claim 1, wherein the first training data set further comprises an application context for the first ML model, wherein the operations further comprise associating the second ML model with the application context.

3. The computer readable media of claim 1, wherein the operations further comprise:
training a statistical model based on the first training data set to estimate human evaluations of the outputs of the first learning model;
applying the statistical model to the first set of system-generated computational metrics to predict a second estimated human evaluation of the target output;
identifying one of the second ML model and the statistical model based at least in part on a first level of accuracy of the first estimated human evaluation and a second level of accuracy of the second estimated human evaluation.

4. The computer readable media of claim 1, wherein the first ML model comprises a generative large language model.

5. The computer readable media of claim 1, wherein the first estimated human evaluation of the target output comprises two or more qualitative metrics.

6. One or more non-transitory computer readable media comprising instructions which, when executed by one or more hardware processors, cause performance of operations comprising:
accessing a first training data set, wherein the first training data set comprises:
a set of system-generated deterministic computational metrics corresponding to a first output of a first ML model;
a qualitative evaluation of the first output of the first ML model generated by a large language model;
training a second ML model, based at least in part on the first training data set, to estimate large language model qualitative evaluations of output of the first ML model;
receiving a target output generated by the first ML model;
executing a machine-evaluation of the target output to generate a first set of system-generated computational metrics corresponding to the target output; and
applying the second ML model to the first set of system-generated deterministic computational metrics to generate a first estimated large language model qualitative evaluation of the target output.

7. The computer readable media of claim 6, wherein the first training set further comprises a human evaluation of the first output of the first ML model, wherein training the second ML model comprises:
applying a first influence weight to the human evaluation of the first output and;
applying a second influence weight to the qualitative evaluation of the first output of the first ML model generated by a large language model;
wherein the first influence weight and the second influence weight are different influence weights.

8. The computer readable media of claim 6, wherein the first training data set further comprises an application context for the first ML model, wherein the operations further comprise associating the second ML model with the application context.

9. The computer readable media of claim 1, wherein the operations further comprise:
training a statistical model based on the first training data set to estimate human evaluations of the outputs of the first learning model;
applying the statistical model to the first set of system-generated computational metrics to generate a second estimated large language model qualitative evaluation;
identifying one of the second ML model and the statistical model based at least in part on a first level of accuracy of the first large language model qualitative evaluation and a second level of accuracy of the second large language model qualitative evaluation.

10. The computer readable media of claim 1, wherein the first ML model comprises a generative large language model.

11. A system comprising:
at least one device including a hardware processor;
the system being configured to perform operations comprising:
accessing a first training data set, wherein the first training data set comprises:
a set of system-generated computational metrics corresponding to a first output of a first ML model;
a human evaluation of the first output of the first ML model;
training a second ML model, based at least in part on the first training data set, to estimate human evaluations of output from the first ML model;
receiving a target output generated by the first ML model;
executing a machine-evaluation of the target output to generate a first set of system-generated computational metrics corresponding to the target output; and
applying the second ML model to the first set of system-generated computational metrics to generate a first estimated human evaluation of the target output.

12. The system of claim 11, wherein the first training data set further comprises an application context for the first ML model, wherein the operations further comprise associating the second ML model with the application context.

13. The system of claim 11, wherein the operations further comprise:
training a statistical model based on the first training data set to estimate human evaluations of the outputs of the first learning model;
applying the statistical model to the first set of system-generated computational metrics to predict a second estimated human evaluation of the target output;
identifying one of the second ML model and the statistical model based at least in part on a first level of accuracy of the first estimated human evaluation and a second level of accuracy of the second estimated human evaluation.

14. The system of claim 11, wherein the first ML model comprises a generative large language model.

15. The system of claim 11, wherein the first estimated human evaluation of the target output comprises two or more qualitative metrics.

16. A system comprising:
at least one device including a hardware processor;
the system being configured to perform operations comprising:
accessing a first training data set, wherein the first training data set comprises:
a set of system-generated deterministic computational metrics corresponding to a first output of a first ML model;
a qualitative evaluation of the first output of the first ML model generated by a large language model;
training a second ML model, based at least in part on the first training data set, to estimate large language model qualitative evaluations of output of the first ML model;
receiving a target output generated by the first ML model;
executing a machine-evaluation of the target output to generate a first set of system-generated computational metrics corresponding to the target output; and
applying the second ML model to the first set of system-generated deterministic computational metrics to generate a first estimated large language model qualitative evaluation of the target output.

17. The system of claim 16, wherein the first training set further comprises a human evaluation of the first output of the first ML model, wherein training the second ML model comprises:
applying a first influence weight to the human evaluation of the first output and;
applying a second influence weight to the qualitative evaluation of the first output of the first ML model generated by a large language model;
wherein the first influence weight and the second influence weight are different influence weights.

18. The system of claim 16, wherein the first training data set further comprises an application context for the first ML model, wherein the operations further comprise associating the second ML model with the application context.

19. The system of claim 16, wherein the operations further comprise:
training a statistical model based on the first training data set to estimate human evaluations of the outputs of the first learning model;
applying the statistical model to the first set of system-generated computational metrics to generate a second estimated large language model qualitative evaluation;
identifying one of the second ML model and the statistical model based at least in part on a first level of accuracy of the first large language model qualitative evaluation and a second level of accuracy of the second large language model qualitative evaluation.

20. The system of claim 16, wherein the first ML model comprises a generative large language model.
